(19) United States
(12) Patent Application Publication
(10) Pub. No.: US 2014/0352822 A1
(43) Pub. Date: Dec. 4, 2014

(54) AIR BLEED VALVE FLOAT ARRANGEMENT WITH RESTRICTOR

(71) Applicant: Eaton Corporation, Cleveland, OH (US)

(72) Inventor: Jeffrey D. Skinner, Madison, MS (US)

(73) Assignee: Eaton Corporation, Cleveland, OH (US)

(21) Appl. No.: 13/907,719

(22) Filed: May 31, 2013

(51) Int. Cl. F16K 24/04

(52) U.S. Cl. CPC F16K 24/042
USPC 137/583

(57) ABSTRACT

A bleed valve assembly includes a control assembly having a fluid inlet, a fluid outlet and a passageway in fluid communication with the fluid inlet and the fluid outlet. A fluid inlet air pressure is greater than a fluid outlet air pressure. An electromechanical valve is disposed in the control assembly and provides selective fluid communication between the passageway and the fluid outlet. A valve assembly is disposed in the passageway of the control assembly and prevents fluid communication of non-gaseous fluid between the fluid inlet and the fluid outlet. The valve assembly includes a float member and a float seat. A flow restrictor is in fluidic communication with the passageway and is configured to maintain a pressure within the assembly such that a change in a gaseous fluid pressure across the valve assembly is insufficient to close the valve assembly.

### INTRODUCTION

The versatility and flexibility of hydraulic systems give them many advantages over other methods of transmitting power. However, like many power systems, proper care of the hydraulic system must be taken in order to prevent problems.

A typical problem that can occur in hydraulic systems is aeration. Aeration in hydraulic systems is commonly caused by air entering the hydraulic system through a leak in an inlet line or as a result of a low fluid level in the reservoir. If the air in the fluid of the hydraulic system is not released, the air will implode against components of the pump. This implosion of air releases large amounts of energy that can result in damage to the pump, which over time can result in premature failure of the pump.

While prior art air-vent valves have been used to release air in the hydraulic system, such valves do not protect against hydraulic leakage from the valve as a result of a valve component failure. Leakage in hydraulic systems can be problematic since it drains the hydraulic system of hydraulic fluid. As the hydraulic fluid of the hydraulic system decreases, the fluid level in the reservoir decreases. As previously stated, the risk of aeration in the hydraulic system increases as the amount of hydraulic fluid in the hydraulic system decreases, which potentially decreases the life of the components of the hydraulic system.

To address these and other issues, a bleed valve assembly is utilized in a hydraulic system. The bleed valve assembly includes a control assembly having a fluid inlet and a fluid outlet and a passageway therebetween. An electromechanical valve is engaged with the control assembly. The electromechanical valve provides selective fluid communication between the passageway and the fluid outlet. A fluid sensor is in fluid communication with the passageway and is in electrical communication with the electromechanical valve. A valve disposed in the passageway of the control assembly prevents fluid communication of nongaseous fluid between the fluid inlet and the fluid outlet. A float ball arrangement in the valve remains open during valve functioning, allowing air to escape. Excess air pressure within the passageway, however, tends to lift the float ball in the valve, thus closing the air passage. Maintaining continuous bleeding of air in such systems, then, can be difficult.

### SUMMARY

In one aspect, the technology relates to a bleed valve assembly having: a control assembly having a fluid inlet, a fluid outlet and a passageway in fluid communication with the fluid inlet and the fluid outlet, wherein a fluid inlet air pressure is greater than a fluid outlet air pressure; an electromechanical valve disposed in the control assembly, wherein the electromechanical valve provides selective fluid communication between the passageway and the fluid outlet; a valve assembly, including a float member and a float seat, wherein the valve assembly is disposed in the passageway of the control assembly, wherein the valve assembly prevents fluid communication of non-gaseous fluid between the fluid inlet and the fluid outlet; and a flow restrictor in fluidic communication with the passageway, wherein the flow restrictor is configured to maintain a pressure within the assembly such that a change in a gaseous fluid pressure across the valve assembly is insufficient to close the valve assembly.

In another aspect, the technology relates to a bleed valve assembly having: a control assembly having a fluid inlet, a fluid outlet and a passageway in fluid communication with the fluid inlet and the fluid outlet, wherein a fluid inlet air pressure is greater than at a fluid outlet air pressure; an electromechanical valve disposed in the control assembly, wherein the electromechanical valve provides selective fluid communication between the passageway and the fluid outlet; a valve assembly, including a float member, a float seat, a valve assembly inlet, and a valve assembly outlet, wherein the valve assembly is disposed in the passageway of the control assembly, wherein the valve assembly prevents fluid communication of non-gaseous fluid between the fluid inlet and the fluid outlet; and a first flow restrictor in fluidic communication with the passageway, wherein the first flow restrictor controls a pressure of a fluid at the valve assembly inlet such that the valve assembly inlet air pressure is less than the fluid inlet air pressure.

In another aspect, the technology relates to a hydraulic system having: a fluid reservoir; a passageway in fluid communication with an upper portion of the fluid reservoir; a fluid sensor in fluid communication with the passageway, the fluid sensor being disposed downstream of the fluid reservoir; an electromechanical valve disposed downstream of the fluid sensor, the electromechanical valve being adapted to selectively vent gaseous fluid in the passageway; a valve assembly disposed in the passageway between the fluid sensor and the electromechanical valve, the valve assembly including a valve seat and a float member, wherein the valve seat and float member are adapted to prevent non-gaseous fluid from flowing downstream of the valve assembly; and a first flow restrictor in fluidic communication with the passageway, wherein the first flow restrictor is configured to maintain a pressure in a portion of the passageway located at least one of upstream and downstream of the valve assembly such that a change in a gaseous fluid pressure across the valve assembly is insufficient to close the valve assembly.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of an embodiment of a hydraulic system having features that are examples of aspects in accordance with the principles of the present disclosure.

FIG. 2 is a schematic diagram of another embodiment of a hydraulic system having features that are examples of aspects in accordance with the principles of the present disclosure.

FIG. 3 is a schematic diagram of another embodiment of a hydraulic system having features that are examples of aspects in accordance with the principles of the present disclosure.

FIG. 4 is a schematic diagram of a control system for a hydraulic system having features that are examples of aspects in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure. The technologies described herein may be utilized in hydraulic systems and hydraulic system bleed valve assemblies, such as those described in U.S. Pat. No. 8,333,217, the disclosure of which is hereby incorporated by reference herein in its entirety.

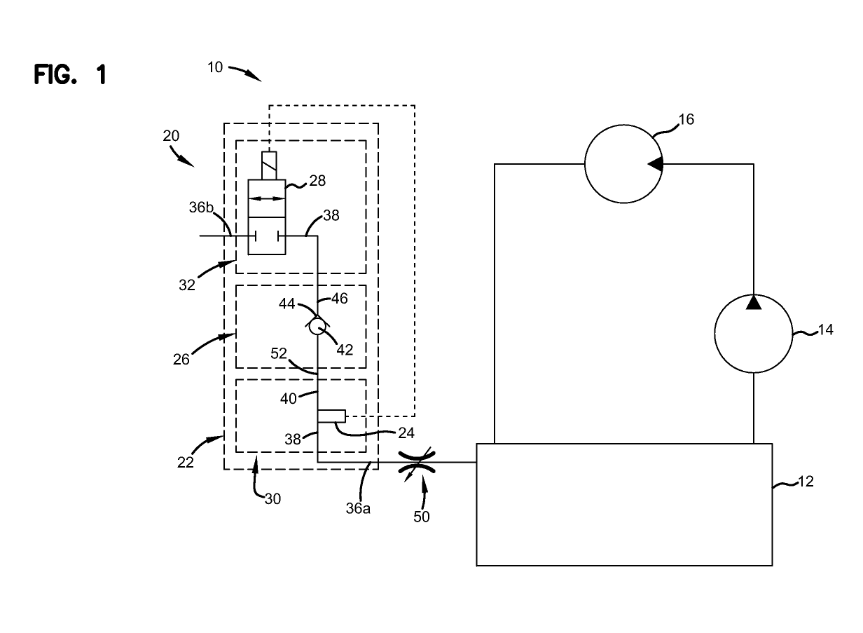

FIG. 1 depicts a schematic representation of one embodiment of a simplified hydraulic system, generally designated 10. The hydraulic system 10 includes a reservoir 12, a pump 14, an actuator 16, which is shown herein as a motor, and a bleed valve assembly, generally designated 20. In one embodiment, the hydraulic system 10 is disposed on an aerospace application such as an aircraft. The reservoir 12 provides a receptacle for holding fluid for the hydraulic system 10. A fluid inlet of the pump 14 and a fluid outlet of the actuator 16 are in fluid communication with the reservoir 12.

As previously stated, a typical problem in hydraulic systems is the presence of air in the hydraulic fluid of the hydraulic system. If this air in the hydraulic fluid of the hydraulic system 10 is not released, the air may implode against components of the pump 14, thereby resulting in potentially damage to the pump 14. In the present embodiment, the bleed valve assembly 20 is adapted to detect and relieve air in the hydraulic system 10. The bleed valve assembly 20 is in fluid communication with an upper portion of the reservoir 12.

The bleed valve assembly 20 includes a control assembly 22. The control assembly 22 includes a fluid sensor 24, a valve assembly 26, and an electromechanical valve 28, each of which will be described in greater detail herein. The control assembly 22 includes a first housing 30 and a second housing 32. In the subject embodiment, the first and second housings 30, 32 are held together in tight sealing engagement. It will be understood, however, that the scope of the present disclosure is not limited to the first and second housings 30, 32 being in tight sealing engagement. That is, the first and second housings 30, 32 could be separately disposed in the control assembly 22.

The first and second housings 30, 32 define a fluid port 36 for receiving or discharging fluid. In the subject embodiment, the first housing 30 defines a fluid inlet port 36a for receiving fluid while the second housing 32 defines a fluid outlet port 36b for discharging fluid. The first and second housings 30, 32 of the control assembly 22 further define a fluid passageway 38 that provides fluid communication between the fluid inlet and outlet ports 36a, 36b. The fluid inlet air pressure at the inlet 36a is higher than the fluid outlet air pressure at the outlet 36b.

The fluid sensor 24 is an electro-optic sensor. Fluid sensors 24 suitable for use with the bleed valve assembly 20 are sold commercially by Eaton-Tedeco as Intellisense LevelPro Series Liquid Level Sensors. Such fluid sensors 24 include a sensing tip, a light source, a light receiver, and a microprocessor. During operation, that is, bleeding of air from the reservoir 12, fluid from the reservoir 12 enters the bleed valve assembly 20 through the fluid inlet port 36a. The fluid enters a first portion 40 of the fluid passageway 38 and comes into contact with a sensing tip of the fluid sensor 24. If the fluid is gaseous, light from the light source of the fluid sensor 24 is refracted through the sensing tip. When the light is refracted through the sensing tip, the light receiver sends a signal to the microprocessor. In response to the signal from the light receiver, the microprocessor actuates a coil of the electromechanical valve 28.

The gaseous fluid in a first portion 40 of the fluid passageway 38 flows around a float member 42, between the float member 42 and a float seat 44. The gaseous fluid then flows into the second portion 46 of the fluid passageway 38. With the coil of the electromechanical valve 28 actuated, the gaseous fluid flows through the second portion 46 and out the fluid outlet port 36b.

If the electromechanical valve 28 remains in the open position rather than returning to the closed position when non-gaseous fluid is disposed in the first portion 40 of the fluid passageway 38, the valve assembly 26 prevents the non-gaseous fluid from entering the second portion 46 of the fluid passageway 38. As the non-gaseous fluid passes into the valve assembly 26, the float member 42 raises and rests within the valve seat 44. The float member 42 rises until it blocks the non-gaseous fluid from entering the second portion 46 of the fluid passageway 38. With the float member 42 blocking the fluid from entering the second portion 46 of the fluid passageway 38, the non-gaseous fluid is prevented from flowing through the fluid outlet port 36b even though the electromechanical valve 28 is in the open position.

The valve assembly 26 of the bleed valve assembly 20 is potentially advantageous as it prevents the reservoir 12 from emptying as a result of erroneous actuation of the electromechanical valve 28 or the electromechanical valve 28 being held in the open position. While in one embodiment the valve assembly 26 is positioned between the fluid sensor 24 and the electromechanical valve 28, the scope of the present disclosure is not limited to the valve assembly 26 being between the fluid sensor 24 and the electromechanical valve 28. In an alternate embodiment, the valve assembly 26 could be positioned between the electromechanical valve 28 and the fluid outlet port 36b. However, with the valve assembly 26 disposed between the fluid sensor 24 and the electromechanical valve 28, the valve assembly 26 keeps the electromechanical valve 28 free from contact with non-gaseous fluid which could potentially improve the life of the electromechanical valve 28. While the bleed valve assembly 20 has been described with regard to air in the hydraulic system 10, it will be understood that the scope of the present disclosure is not limited to using the bleed valve assembly 20 in a hydraulic system as the bleed valve assembly 20 could be adapted for relieving any gaseous fluid from a non-gaseous fluid system.

It has been discovered that high airflows through the bleed valve assembly 20 can cause the float member 42 to inadvertently engage the float seat 44, thus closing off airflow, even if only gaseous fluid is present in the valve assembly 26. This can occur, for example, when the electromechanical valve 28 is opened fully, thus causing a significant pressure drop through the valve assembly 26. The force of the hydraulic fluid compressing the column of air between the hydraulic fluid and the valve assembly 26 may be sufficient to overcome the weight of the float member 42, thus lifting the float member 42 into engagement with the float seat 44. For continuous bleeding of air, control of vertical displacement of the float member 42 is desirable. A flow restrictor 50 may be utilized control the displacement. Thus, the operating pressure range of the valve assembly 26 can be adjusted by sizing of the restrictor 50, without altering the internal float member 42/float seat 44 arrangement. Modification of the valve assembly 26 is not desirable, due to space constraints within control assembly 22.

In the hydraulic system of FIG. 1, the flow restrictor 50, in this case, an adjustable flow restrictor is disposed external to the control assembly 22, and forms a part of the air bleed assembly 20. In other embodiments of the various systems depicted herein, the flow restrictor is not adjustable. The flow restrictor 50 is located in fluidic communication with the passageway 38, upstream of the fluid inlet port 36a. The presence of the flow restrictor 50 reduces the pressure drop across the valve assembly 26. More specifically, when located upstream of the valve assembly 26, the flow restrictor 50 controls flow through the passageway 38, such that the force present at an inlet 52 of the valve assembly 26 is less than the weight of the float member 42. Thus, the float member 42 does not contact the float seat 44. Regardless of the location of the flow restrictor 50 in the passageway 38, the flow restrictor 50 maintains a pressure within the control assembly 22 such that a change in a gaseous fluid pressure across the valve assembly 26 is insufficient to close the valve assembly 26.

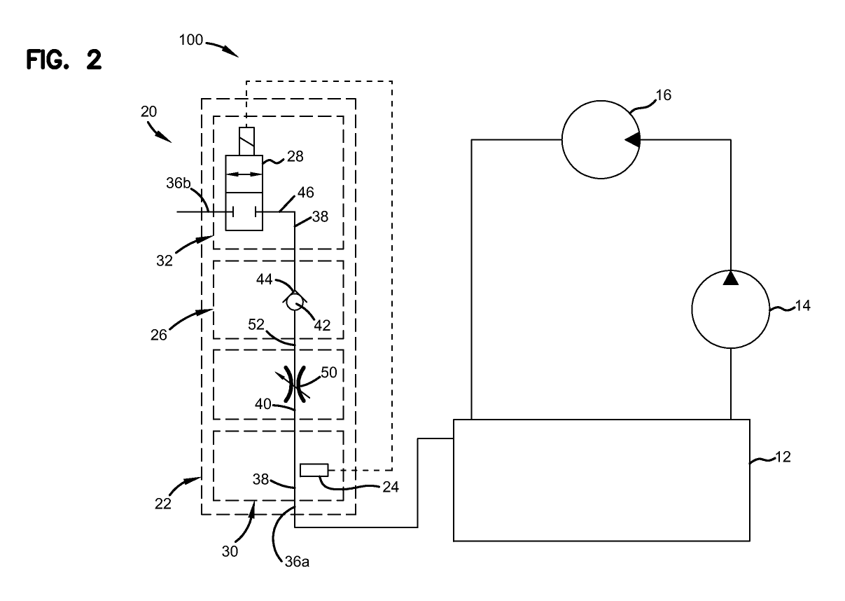

FIG. 2 depicts an alternative embodiment of a hydraulic system 100 utilizing a flow restrictor 50 to prevent excessive pressure from closing the valve assembly 26. The various components of the system 100 are described above with regard to FIG. 1. A significant difference between the system 100 and the system 10 of FIG. 1 is the location of the flow restrictor 50. In this system 100, the restrictor 50 is disposed within the control assembly 22, and forms a part of the air bleed assembly 20. The purpose of the flow restrictor 50 is similar to that of the flow restrictor 50 of FIG. 1, that is, to reduce the force of the airflow at the valve assembly inlet 52. This reduction in force is the result of the flow restrictor 50 maintaining a pressure within the control assembly 22 such that a change in a gaseous fluid pressure across the valve assembly 26 is insufficient to close the valve assembly 26.

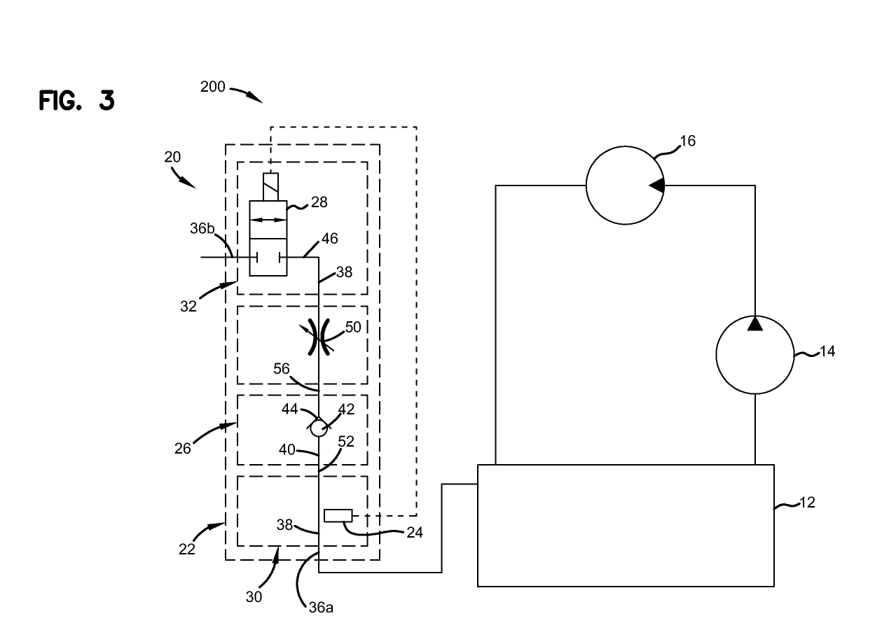

FIG. 3 depicts another embodiment of a hydraulic system 200 utilizing a flow restrictor 50 to prevent excessive pressure from closing the valve assembly 26. The various components of the system 200 are described above with regard to FIG. 1. In the system 200 of FIG. 3, the flow restrictor 50 is disposed within the control assembly 22, downstream of the valve assembly 26, in the second portion 46 of the fluid passageway 38. In this system 200, the restrictor 50 causes a higher pressure at the valve assembly outlet 56. With higher pressures at both the inlet 52 and the outlet 56, then, the pressure drop across the valve assembly 26 is reduced (as compared to a system that does not utilize a flow restrictor), thus reducing or eliminating the likelihood of closing the valve assembly 26. Of course, the pressures within the system 200 are based on normal operating conditions of a hydraulic system, for example, a hydraulic system located on an aircraft.

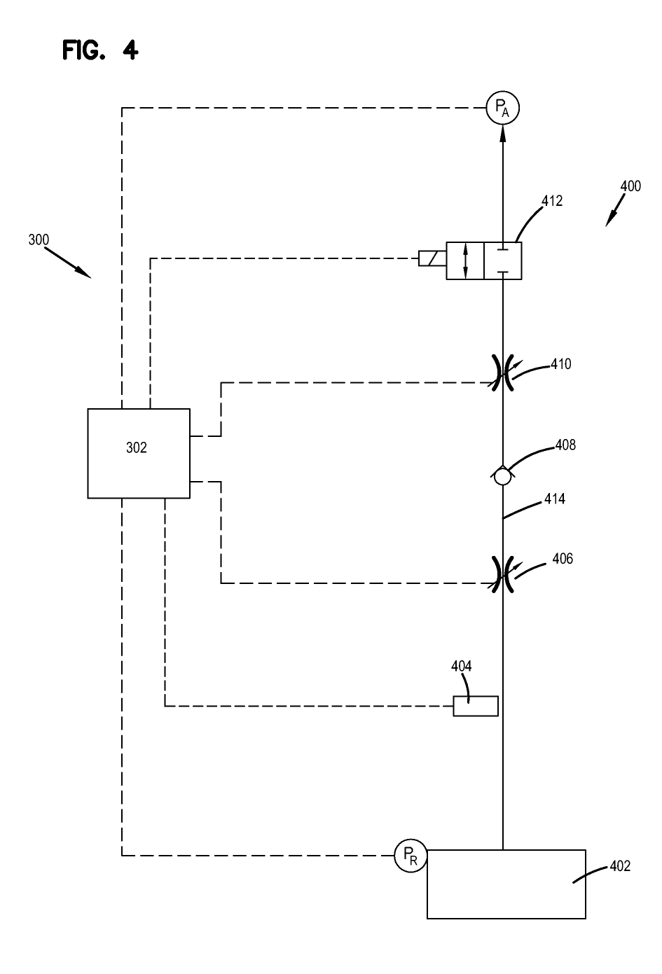

FIG. 4 depicts a control system 300 for a hydraulic system 400. The hydraulic system includes a reservoir 402, a fluid sensor 404, and a first flow restrictor 406 located upstream of a valve assembly 408. An optional second flow restrictor 410 may be located downstream of the valve assembly 408. An electromechanical valve 412 controls airflow through the fluid passageway 414 that connects the various components. A microprocessor/controller 302 is connected to the various components, as required or desired for a particular application. In the embodiments of the various hydraulic systems depicted in FIGS. 1-3, the fluid sensor 24 is in communication with the electromechanical valve 28, which closes based on a signal from the fluid sensor 24. In the depicted control system 300, a controller 302 processes the signals sent from the fluid sensor 404 and actuates the electromechanical valve 412 accordingly.

The controller 302 may utilize signals sent from other components of the hydraulic system 400 to control operation thereof. For example, the control system 300 may also include one or more pressure sensors, for example a reservoir pressure sensor P_{R} that detects pressure within the reservoir and/or an ambient pressure sensor P_{A} that detects ambient pressure. If, the detected difference between the reservoir pressure P_{R} and the ambient pressure P_{A} is not significant, the controller 302 may open either or both of the flow restrictors 406, 410 to the fully open position, prior to actuating the electromechanical valve 412. Alternatively or additionally, the controller 302 may actuate the second flow restrictor 410 to a fully open position, and actuate the first flow restrictor 406 to a preferred position, so as to control the pressure drop through the valve assembly 408 when the electromechanical valve 412 is opened. In such an embodiment, the second flow restrictor 410 may be actuated from a fully-open position to a less-open position should the electromechanical valve 412 fail in the fully open position. Thus, the second flow restrictor 410 may function as a redundant electromechanical valve, so as to mitigate or eliminate adverse effects of component failure. In other embodiments, the electromechanical valve 412 may be actuated simultaneously with either or both of the flow restrictors 406, 410, so as to more accurately control bleeding from the system 400. Other control sequences will be apparent to a person of skill in the art.

The electronic controller 302 may be loaded with the necessary software or firmware required for use of the system 300. In alternative configurations, software may be included on various types of storage media (CDs, DVDs, USB drives, etc.) for upload to a standard PC, if the PC is to be used as the controller, or if the PC is used in conjunction with the hydraulic system as a user or service interface.

The control technology described herein can be realized in hardware, software, or a combination of hardware and software. The technology described herein can be realized in a centralized fashion in one computer system or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein. Since the technology is also contemplated to be used on aviation equipment, however, a stand-alone hardware system including the necessary operator interfaces may be desirable.

The technology described herein also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A bleed valve assembly comprising:
a control assembly having a fluid inlet, a fluid outlet and a passageway in fluid communication with the fluid inlet and the fluid outlet, wherein a fluid inlet air pressure is greater than a fluid outlet air pressure;
an electromechanical valve disposed in the control assembly, wherein the electromechanical valve provides selective fluid communication between the passageway and the fluid outlet;
a valve assembly, including a float member and a float seat, wherein the valve assembly is disposed in the passageway of the control assembly, wherein the valve assembly prevents fluid communication of non-gaseous fluid between the fluid inlet and the fluid outlet; and
a flow restrictor in fluidic communication with the passageway, wherein the flow restrictor is configured to maintain a pressure within the assembly such that a change in a gaseous fluid pressure across the valve assembly is insufficient to close the valve assembly.

2. The bleed valve assembly of claim 1, wherein the flow restrictor is disposed on an upstream side of the valve assembly.

3. The bleed valve assembly of claim 1, wherein the flow restrictor is disposed on a downstream side of the valve assembly.

4. The bleed valve assembly of claim 1, wherein the flow restrictor comprises a first flow restrictor disposed on an upstream side of the valve assembly, and a second flow restrictor disposed on a downstream side of the valve assembly.

5. The bleed valve assembly of claim 1, further comprising a fluid sensor in fluid communication with the passageway, the fluid sensor being in electrical communication with the electromechanical valve.

6. The bleed valve assembly of claim 1, wherein the flow restrictor is adjustable.

7. A bleed valve assembly comprising:
a control assembly having a fluid inlet, a fluid outlet and a passageway in fluid communication with the fluid inlet and the fluid outlet, wherein a fluid inlet air pressure is greater than at a fluid outlet air pressure;
an electromechanical valve disposed in the control assembly, wherein the electromechanical valve provides selective fluid communication between the passageway and the fluid outlet;
a valve assembly, including a float member, a float seat, a valve assembly inlet, and a valve assembly outlet, wherein the valve assembly is disposed in the passageway of the control assembly, wherein the valve assembly prevents fluid communication of non-gaseous fluid between the fluid inlet and the fluid outlet; and
a first flow restrictor in fluidic communication with the passageway, wherein the first flow restrictor controls a pressure of a fluid at the valve assembly inlet such that the valve assembly inlet air pressure is less than the fluid inlet air pressure.

8. The bleed valve assembly of claim 7, wherein the first flow restrictor is disposed external to the control assembly.

9. The bleed valve assembly of claim 7, wherein the first flow restrictor is disposed within the control assembly.

10. The bleed valve assembly of claim 7, further comprising a fluid sensor in fluid communication with the passageway, the fluid sensor being in electrical communication with the electromechanical valve.

11. The bleed valve assembly of claim 7, wherein a force generated by a difference between the valve assembly inlet air pressure and the fluid outlet air pressure is less than a weight of the float member.

12. The bleed valve assembly of claim 7, further comprising a second flow restrictor in fluidic communication with the passageway, wherein the second flow restrictor is configured to reduce a pressure drop from the valve assembly inlet to the valve assembly outlet.

13. The bleed valve assembly of claim 7, further comprising a second flow restrictor disposed between the valve assembly and the electromechanical valve.

14. The bleed valve assembly of claim 7, wherein the flow restrictor is adjustable.

15. A hydraulic system comprising:
a fluid reservoir;
a passageway in fluid communication with an upper portion of the fluid reservoir;
a fluid sensor in fluid communication with the passageway, the fluid sensor being disposed downstream of the fluid reservoir;
an electromechanical valve disposed downstream of the fluid sensor, the electromechanical valve being adapted to selectively vent gaseous fluid in the passageway;
a valve assembly disposed in the passageway between the fluid sensor and the electromechanical valve, the valve assembly including a valve seat and a float member, wherein the valve seat and float member are adapted to prevent non-gaseous fluid from flowing downstream of the valve assembly; and
a first flow restrictor in fluidic communication with the passageway, wherein the first flow restrictor is configured to maintain a pressure in a portion of the passageway located at least one of upstream and downstream of the valve assembly such that a change in a gaseous fluid pressure across the valve assembly is insufficient to close the valve assembly.

16. The hydraulic system of claim 15, further comprising a second flow restrictor in fluidic communication with the passageway, wherein the second flow restrictor is configured to maintain a pressure downstream of the valve assembly such that a change in a gaseous fluid pressure across the valve assembly is insufficient to close the valve assembly.

17. The hydraulic system of claim 15, further comprising a controller for controlling actuation of the electromechanical valve based at least in part on a signal received from the fluid sensor, wherein the controller closes the electromagnetic valve when the fluid sensor detects a presence of a non-gaseous fluid in the passageway.

18. The hydraulic system of claim 17, wherein the controller actuates at least one of the first flow restrictor and the second flow restrictor based at least in part on a signal sent from the electromechanical valve.

19. The hydraulic system of claim 15, further comprising a pump and an actuator in fluidic communication with the reservoir.

20. The hydraulic system of claim 19, wherein the hydraulic system is disposed in an aircraft.
